(19) United States
(12) Patent Application Publication
(10) Pub. No.: US 2025/0151640 A1
(43) Pub. Date: May 15, 2025

(54) WIDE ANGLE DISTRIBUTOR OF SOLID AND/OR LIQUID MATERIALS FOR PNEUMATIC FERTILIZER MACHINES AND/OR SEEDERS

(71) Applicant: INDECAR MAQUINARIAS S.A., Caba (AR)

(72) Inventor: Sergio Gastón Ricardo, Caba (AR)

(73) Assignee: INDECAR MAQUINARIAS S.A., Caba (AR)

(21) Appl. No.: 18/506,680

(22) Filed: Nov. 10, 2023

(51) Int. Cl. A01C 7/08; A01C 15/00; A01C 23/00

(52) U.S. Cl. CPC A01C 7/085; A01C 15/008; A01C 23/003

(57) ABSTRACT

A wide angle distributor of solid and/or liquid materials for pneumatic fertilizer and/or sowing machines that allows for a much more homogeneous spread of the fertilizer or granular material due to a novel spreading plate thereof that has a faceted surface that prevents the material accumulation and, in turn, provides a more homogeneous distribution and in a larger width than through the conventional spreading spouts of the prior art, and the wide angle distributor of the invention may vary its height in order to be adapted to the different materials and soil conditions in order to provide a correct and proper material spread on the surface.

### FIELD OF THE INVENTION

This invention relates to the field of devices, arrangements or means for metering granular materials and/or solid or liquid fertilizers and, more particularly, it relates to a wide angle distributor of solid materials, fertilizers, amendments and/or seeds, granulates or powder, or mixtures thereof and liquids, that allows for a uniform and customized spreading of each material and for each soil height by means of the arrangement of a novel convex surface spreading plate that regulates the height.

Whenever in this description reference is made to a fertilizing material spreading spout, it is clear that this invention may be used without any inconvenience for pneumatic fertilizer machines, pneumatic seeders/fertilizer machines usually known as “cover seeders”, fumigators, for any agricultural work and in those places where there is the need of a uniform and homogeneous spreading of the above-mentioned materials as well as any other material that may be spread by means of a pressurized cold or hot air flow and carried within tubes/ducts until they are released through the terminal end of said tubes/ducts and spread by means of the wide angle distributor of this invention.

### DESCRIPTION OF THE PRIOR ART

Various models of fertilizer machines and implements for the application of solid material are known in the field of the art, such as those created for the application of covers, known as “broadcast”, solid fertilizers in the form of both granulates and powder, with various work capacities but all of which seek to obtain a uniform, homogeneous and correct distribution and a proper metering throughout the land to be tilled, while assuming a low coefficient of variability.

They are agricultural implements and machinery suitable for the distribution and application of any solid product or mixtures thereof: fertilizers, toxic baits, mineral fertilizers, physical mixtures, salts, seeds (oat, rice, Australian barley, etc., or for sowing in pasture rejuvenation plans) or liquids. Among them, there exist those ones that use a pneumatic fluid for the transport and metering of the material to be metered and they may be grouped into those ones that distribute solid materials by free fall from the end point of the tube/duct terminals (without spreading spouts) to the soil and those which include the use of spraying spouts at the outlet of the tube/duct terminals, which goal consists in receiving the influx of the material entrained by the pneumatic fluid through rigid tubes/ducts and/or hoses, and generating the “broadcast” application in the best possible way so that, while accompanying the forward motion of the agricultural implement or machine, said material is distributed in a way as homogenous and uniform as possible along the tillage length and width.

As a result of different variables, but mainly variables related to the height in relation to the soil, the spreading spout shape, the distance between the end point of the terminal body of the tube and the diffuser plate and, certainly, the physical characteristics of the product type to be applied, the diffuser or wide angle distributor shall perform the material diffusion at a pre-determined width. The sum of all of the spreading spouts included in the agricultural implement and/or machine, in the most suitable arrangement for the work, shall perform the best spreading and work width as required.

In the particular case of the most known diffuser spouts, those spouts made of a flat metal plate in which a portion thereof is slightly slanted towards the ground, or others in which the metal plate is developed perpendicularly to the ground and located in the portion of contact with the tube/conduct terminal end, to define thereafter and in the medium area of the plate an angle of about 135°, which vertexes are in a direction opposite the machine direction of travel, or those that use a conical structure as a diffusion means in which the its convex/concave area is exposed to the material and its base faces the ground, and all of them are coupled to the unloading end of the tube or hose that provides the material entrained by the pressurized air stream, and all of the elements are attached to a supporting unit configured for a fixed and stable mounting.

The purpose of both groups is that the material impacts on the diffuser plates and that due to the rebound effect, the material is spread in a greater or lesser extent of amplitude than that obtained in the end point of the tube/duct.

Various shapes and sizes have thus been developed based on the diffuser spout types according to the intrinsic characteristics of the agricultural implements and/or machines, but all of them have a greater or lesser degree of deficiency in the application process, as in the case in which the flat metal plate is used and the solid material leaves the end of the tube/duct terminal with great strength and hits the diffuser plate thus exploding and causing to a large extent the breakage of the material to be applied and, consequently, generating smaller particles.

This negative effect is reduced in conical-shaped spouts wherein the material is exposed to the concave area of the spout and the spout base is faced to the ground, but due to the smooth design, it has been possible to verify that upon hitting the diffuser plate, the material particles have an elliptical movement with their larger size perpendicular to the ground, and they are thereby exposed to the environmental inclemencies during a period of time longer than necessary and, specially, to the wind strength, which is the main cause of the unnecessary non-controlled diffusion of the material.

Furthermore, flat plates do not take advantage of the beneficial properties of the pressurized air stream that entrains the material through tubes/ducts thus enabling the material to fall practically due to the effect of gravity while conical-shaped plates, in which the material is exposed to the concave area of the plate and the plate base faces the ground, intensify the use of the pressurized air stream to help the material fall, but they may generate negative actions since they force the material to form undesired movements and, consequently, deficiencies are generated in the homogeneous application.

Any material that suffers the rupture of its initial conformation thus producing smaller particles as a result of hitting the diffuser plate shall force said particles to have a different behavior from the rest of the material that maintains its integrity and, consequently, shall directly affect the uniformity, extent and spreading of the application, which unavoidably involves technical inefficiencies of the treatment and present and future economic losses.

In those cases in which the wind is too strong, it becomes difficult to achieve uniform, precise and efficient applications that are also technically profitable in the future since the material to be metered is practically entrained with extreme ease by the environmental wind stream. This situation is highly appreciated since the time in the field is very significant and, in many cases, it is possible that the application work that needs to be postponed may not be carried out in another moment during the ongoing sowing campaign, which inevitably leads to a loss of technical efficiency and profitability.

Moreover, the currently existing diffuser spouts are generally bodies consisting of a set of multi-shape geometric figures which arrangement sequence requires that they are rigid and resistant and they may be made of stainless steel, wrought iron, plastic, carbon fiber, and any other material that is sufficiently resistant to the aggression exerted by the product/s and/or mixtures of products that are intended to be applied and, in turn, accompany the lifetime of the fertilizer implement or sowing machine with the consideration that the environment where its working capacity shall be developed is not precisely benign but quite the opposite.

According to the material chosen for their manufacture, it is important to use corrosion protective coatings, due to both the products to be applied and the natural inclemencies, whether paintings and/or special treatments, but without excluding the possibility of using them just for advertising, trademark or merely ornamental purposes.

Irrespective of the material available for the manufacture thereof, its incorporation in the tillage implement and/or pneumatic seeder seeks to ensure the correct distribution both as to the distance and uniformity of the materials and/or mixtures thereof, whether seeds, solid bodies or powder, and liquid, in soil tillage processes, sowing and/or fumigation.

In the course of time, various types of diffuser spouts have been proposed with the implementation and fixing to the main structure, such as couplings and/or extensions in the terminal point of the tubes/ducts that carry the material to be spread, as well as to the wing or boom structure of an agricultural fertilizer machine, and, among said types, the spout having a plate with a certain angle of inclination to the parallelism of the ground and in a direction opposite the natural forward direction of the machine is distinguished, wherein, despite the fact of not being optimal in their function, smooth surface figures of various geometries manage to mitigate the agglomeration of the material to be deposited on the soil, but all of them are designs that have the shortcoming of being rigid and attached to the wing or boom body, or to the terminal point of the tube/duct length of travel that carries the material to be spread, thus preventing the correction of the spreading effect owing to the fact that there are different types of materials and/or mixtures thereof, or seeds, which are the application basis, or simple because of not properly solving its attack radius and convergence with adjacent spouts.

One type of wide angle distributor is that disclosed in the Utility Model Document AR 102883 B4 owned by MAMASU S.R.L., which describes a diffuser spout that comprises a rigid body that defines a spreading plate slightly slanted to the ground and has a concave surface which originates from an upper flap which lower edge determines a fold line that follows a path of an inverted “V” shape, from which the same plate projects forwards and downwards thus defining a surface with curved front and lower edges.

Although this wide angle distributor has a spreading plate which concavity faces the coupling tube, from which the fertilizer or granular material falls, it is rigid and has a smooth surface, as a consequence of which it also has the above-mentioned shortcomings. Likewise, the feature of having an upwardly-curved front edge significantly limits the spreading radius of the fertilizer or granular material to be deposited on the soil, thus turning the application deficient in practice.

By virtue of the current available state of the art for the metering or spread of liquid and/or solid fertilizer materials or bulk materials, it would be convenient to have a new arrangement that allows for a more homogeneous spread that is adapted to the different soil conditions and/or each material in order to turn the fertilization and/or sowing into a much more efficient process.

### BRIEF DESCRIPTION OF THE INVENTION

It is therefore an object of the present invention to provide a new wide angle distributor of liquid and/or solid fertilizer material used in fertilizer machines that allows for a material distribution or spread in a much more uniform way or covering a larger surface.

It is a further object of the present invention to provide a wide angle distributor that adapts to the requirements of the soil and materials to be metered by gradually varying its height.

It is another object of the present invention to provide a wide angle distributor that comprises a novel spreading plate having a conical geometry which convex surface faces the exit of the fertilizer or granular material.

It is still another object of the present invention to provide a conical spreading plate comprising a plurality of sections or faces that define a faceted pyramidal spreading plate in order to contribute with the control of the confluence and spread of the material, while preventing any type of material accumulation or agglomeration.

It is still a further object of the invention to provide a wide angle distributor that may make a 180° angular movement in relation to the ground and which effects to be obtained in the spreading process of materials and/or the mixture thereof and/or seeds, or liquids, shall be sufficient to achieve a better homogeneous dispersion, whether in certain materials to be applied or in the land to be tilled.

It is another object of the present invention to provide a wide angle distributor which size and conformation make it possible to use it in various agricultural implements and machines, without the need to make any modification in its design and/or mode of use.

It is a further object of the present invention to provide a wide angle distributor of solid and/or liquid materials for pneumatic fertilizer machines and/or seeders of the type comprising a spreading plate that receives the material to be unloaded from and in operative communication with an unloading opening or outlet of a coupling tube, which, in turn, is provided above an inlet or coupling opening of an unloading tube/duct through which a pressurized air stream flows and entrains the material to be unloaded, and said spreading plate comprises a conical geometry which convex surface faces said unloading opening or outlet of said coupling tube.

### BRIEF DESCRIPTION OF THE DRAWINGS

For greater clarity and understanding of the object of the present invention, it is illustrated in several figures, in which the invention is represented in one of the preferred embodiments, all of which are provided by way of example, wherein:

FIG. 1 shows a front view of the wide angle distributor according to the present invention.

FIG. 2 shows another front view of the wide angle distributor of the invention, wherein the coupling tube is at a position closer to a spreading plate according to one of the aspects of the present invention;

FIG. 3 shows a perspective view of the wide angle distributor of FIG. 1; and

FIG. 4 shows a perspective view of the wide angle distributor of FIG. 2.

### DETAILED DESCRIPTION OF THE INVENTION

With reference now to the figures, it may be seen that the invention consists in a wide angle distributor of solid and/or liquid materials for pneumatic fertilizer machines and/or seeders that allows for a much more homogeneous spread of the fertilizer or granular material due to its novel spreading plate having a faceted convex surface that prevents material accumulations and, in turn, provides a more uniform distribution in a larger width than through the conventional spreading spouts of the prior art, and the height of the wide angle distributor of the invention may also be varied in order to be adapted to the different materials and soil conditions to provide the correct and proper spread of the material on the surface.

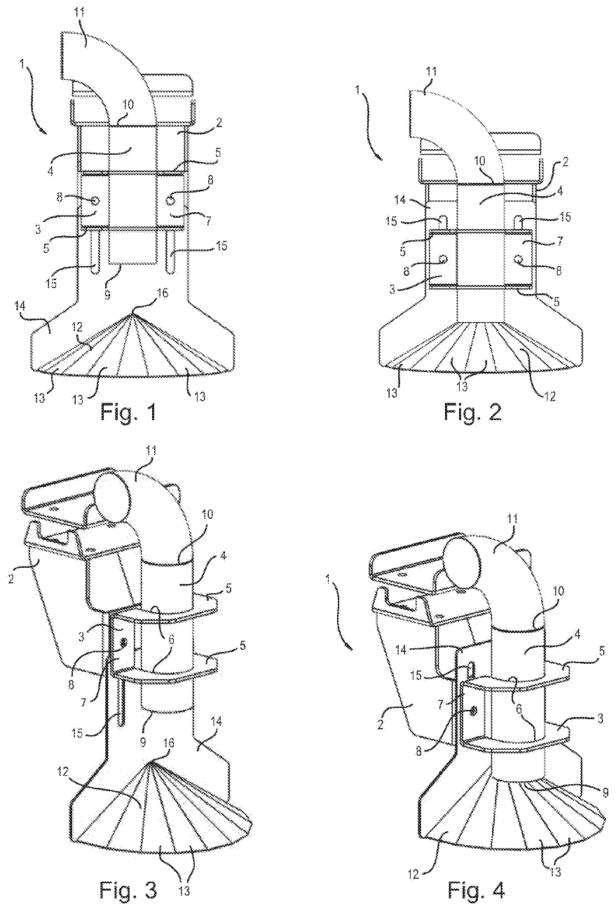

In this way, and according to FIGS. 1 to 4, the wide angle distributor of the present invention is indicated by means of the general reference 1 and it is to be mounted on a corresponding part of the wing or boom 2 of an agricultural machine, whether a fertilizer and/or a pneumatic seeder/fertilizer, among others and without limitation for the invention. Each corresponding part of a wing or boom 2 that constitutes the agricultural machine has two respective holes (not illustrated) for fixation of a respective support 3 of a coupling tube 4.

Said support 3 comprises a “C”-shaped structure, which horizontal wings 5 have corresponding cuts or recesses 6 for the fixation of said coupling tube 4 therein, and its vertical wing 7 is provided with respective fixation holes 8 which position coincide with the position of the holes of each corresponding part of a wing or boom 2 and through which some fixing elements (not illustrated) pass, which allow for the support 3 fixation in said corresponding part of a wing or boom 2. Said fixing elements may be selected from the group consisting of studs, screws, bolts, or the like. Likewise, said coupling tube 4 comprises an unloading opening or outlet 9 and an inlet or coupling opening 10 to couple an unloading tube/duct 11 through which a pressurized air stream entraining the fertilizer or granular material to be unloaded flows.

It is clarified that there will be as many wide angle distributor units as corresponding part units of wing or booms 2 exist in each agricultural machine, but this feature is not limitative for the invention since the number of wide angle distributor may be adapted to the convenience of each user.

This invention also comprises a spreading plate 12 that comprises a generally conical geometry, which convex surface faces said unloading opening or outlet 9 of said coupling tube 4. That is to say that said convex surface is exposed to the pressurized hot or cold air stream and the material entrained in said stream, while its base is arranged in a direction parallel to the ground. Preferably, but without limitation for the invention, said spreading plate 12 comprises a pyramidal structure provided with a plurality of faces or sections 13 that define a faceted surface that allows for a more homogeneous distribution or dispersion of the material.

It is to be noted that the plurality of sections or faces 13 that define the faceted surface of the spreading plate 12 enable the wide angle distributor of the invention to be adjusted to the new materials and/or uses according to the use of agricultural implements and/or machines without the need to alter the design and/or mode of use of the set of elements that compose it.

Likewise, and in contrast to the prior art, said spreading plate 12 may be adjusted in its height, either near or away from said unloading opening or outlet of the coupling tube 4 depending on the material to be spread and the soil conditions. For this purpose, said spreading plate 12 is mounted on a lower portion of a height adjusting plate 14 provided with at least respective through sliding paths 15 parallel to each other. The height adjusting plate 14 is arranged between the vertical wing 7 of the support 3 and the corresponding part of the wing or boom 2 of the machine, which comprises holes for fixing the wide angle distributor parts. Said through sliding paths 15 are thus arranged in coincidence with the holes of the boom 2 and support 3, and the height adjusting plate 14 remains selectively fixed by means of said fixing elements.

As an example, but not limitative for the invention, said height adjusting plate 14 comprises a pluri-polygonal flat and rigid figure that is substantially longer than wide, in which in its mostly narrower section, said through-sliding paths are defined, and said through-sliding paths are longitudinal hollow and parallel through-holes that allow for their vertical movement in relation to both fastening points arranged in the element of assembling and fixing to the wings or booms, since said spreading plate is developed from the mostly wider section.

As a result of having said through sliding paths 15 of a certain length, the height adjusting plate 14 may be moved upwards so that said spreading plate 12 and, more particularly, its vertex 16, may be selectively positioned close to or far apart from said unloading opening or outlet 9 of the coupling tube 4 depending on the material to be spread and the soil conditions. Therefore, a proper and correct position of the spreading plate 12 is provided so that the spread is as homogeneous as possible while covering a larger width and, in turn, by varying the height, properly covering the depth in the soil. Likewise, the aggression of the material to be spread onto the crops is reduced by allowing for the vertical movement of the spreading plate in relation to the soil.

Furthermore, the height adjustment is performed just by loosening or unfastening the fixing elements and vertically moving the adjusting plate 14 either upwards or downwards as necessary. Once the fixing elements are placed in the proper position, they are adjusted again and the other general adjustments of the pneumatic fertilizer machine or seeder/fertilizer are made.

In a more detailed description related to the general functioning and operation form of the wide angle distributor of the present invention, but without limitation therefor, in a first embodiment and as a preventive measure for the correct provision of its work capacity, it is necessary to verify and control that every wide angle distributor is correctly integrated and fixed to the corresponding agricultural implement or machine and connected by means of the coupling tube to each end of the tubes/ducts through which the pressurized hot or cold air that entrains the material flows. Once this process is completed, the corresponding adjustments that shall make it possible to determine its work width, resistance to strong winds, continuity in the individual travel, uniformity of the application and homogeneous spread of the material to be applied, are then made.

For the above-mentioned purpose, the wide angle distributor of the present invention shall be focused first by establishing the minimum feasible distance of the vertex of the spreading plate from the free end of the coupling tube, for which it is necessary to loosen the fixing elements (i.e. studs) that keep the height adjusting plate and the support of the coupling tube attached to the respective part of the “wings or boom”. After completion of this process, the height adjusting plate is pushed until the sliding paths abut against the fastening studs. Upon achieving this movement, the previously unfastened studs are then fastened, thus keeping the whole set attached between each other and to the “wing or boom”. The same procedure must be carried out in each and every one of the wide angle distributors.

Next, the whole pressurized air circuit shall be actuated, the values to be obtained during the application shall be entered on the monitor and, finally, while keeping the agricultural implement or machine on which the wide angle distributors have been mounted in static state, a “control bag” shall be placed in each and every wide angle distributor in order to obtain calibration information related to the air pressure and the dosage of material to be applied. The complete fertilization circuit shall be started up and its behavior shall be observed, the contents of the “control bags” shall be checked, and, if necessary, the values entered on the control monitor shall be adjusted until the intended dosage is achieved. Once this process is concluded, the “control bags” of each and every wide angle distributor shall be definitely removed, thus allowing to begin the control of homogeneity, spreading and overlap among wide angle distributors on the soil.

Under the same above-mentioned operating conditions, the complete fertilization circuit shall be started up, wherein the behavior of the material to be applied in the tillage is observed:
1. —The overlap of material of the wide angle distributor in relation to the adjoining wide angle distributors shall be visually verified.
2. —The homogeneity of the material spread on the soil shall be verified in the same way.
3. —The same methodology shall be used to control the material covering distance, which shall be taken from the wide angle distributor to the place where a minimum accumulation of the spread material has been seen.
4. —The integrity of the material to be applied must be identified, and said material to be applied shall mostly keep its physical characteristics.
5. —Finally, the closeness of the material to be applied in relation to the soil shall be controlled, and said material shall pass across the existing crops and make contact with the soil.

After having surveyed the material spread characteristics, the need to apply or not to apply the correction of the distance between the free end or unloading opening/outlet of the coupling tube and the spreading plate vertex shall be analyzed taking the action and the effects thereof into account:
1. —The larger the distance between the spreading plate vertex and the free end or unloading opening/outlet of the coupling tube is, the greater the overlap of the material of the wide angle distributor in relation to its adjoining spouts, the greater the material covering distance when measured from the wide angle distributor to the place where a minimum accumulation of spread material has been seen, and the greater the conservation of the material physical characteristics shall be.
2. —The shorter the distance between the spreading plate vertex and the free end or unloading opening/outlet of the coupling tube is, the less the overlap of the material of the wide angle distributor in relation to its adjoining spouts, the less the material covering distance when measured from the wide angle distributor to the place where a minimum accumulation of spread material has been seen, the less the conservation of the material physical characteristics, and the greater the concentration as well as the closeness to and penetration into the soil shall be.

In this way, the wide angle distributor of the present invention is composed and built, which due to its novel spreading plate structural configuration, which may also be adjusted in height, allows for a better and more homogeneous distribution of the fertilizer or granular material on the soil. In this way, there is provided a wide angle distributor for the application of materials or mixtures thereof, such as seeds, solid bodies or powder, and liquids, that is suitable for spreading individual or mixed solid materials, fertilizers, correctors, and seeds, whether in granulate o powder form, or mixtures thereof, as well as liquids.

Likewise, the invention considers the factor that in view of dealing with materials having different shapes, specific weight and hardness, as essential characteristics, when a uniform and homogeneous distribution is required, there is now the possibility of varying the distance between the final end of the outlet terminal of the material carried by the tubes/ducts and the spreading plate due to the novel structural configuration of the wide angle distributor of the present invention, which allows for its vertical adjustment or an adjustment in its height, since without this function of height variability, it would be assumed that there are not physical differences among the various materials and/or seeds to be added to the soil and, consequently, the fertilizer or sowing process would not be suitable or correct, as in the case of the spreading spouts of the prior art.

In addition to the above and in line with the problems described in the Prior Art section, the plates with a concave and smooth surface of the conventional spouts neither consider the physical differences among the materials and/or seeds to be used nor the tillage conditions in lands where there are crops of considerable height, wherein it is shown that the modification of the height of the boom or wing of the machinery or implement is not always the solution to the problem.

In contrast to the prior art, and as described hereinabove, the present invention incorporates a significant characteristic since it provides the spreading plate with a vertical motion in relation to the soil, thus making it possible to move it away from or closer to the end point of the coupling tube and the terminal of the tubes/ducts that carry the material to be spread, by correcting the material attack angle on the spreading plate, thus achieving a substantial improvement in the uniformity, radial scope, homogeneity and integrity of the product/seed to be spread, as well as the coverage confluence with adjacent spouts.

In turn, by adjusting the spreading plate height, the invention makes it easier to significantly alter the material coverage area on the soil as a result of the product diversity and variation of the specific product weights, and, from a different point of view, it extends the lifetime of the spreading plate owing to the fact that it modifies the area of the hitting exerted by the material to be applied.

Likewise, the geometric shape defined for the constitution of the spreading plate of the present invention is of crucial importance to achieve the desired effect of a correct dispersion, and it is verified that the best behavior and adaptation to the intended use corresponds to the convex section of a pyramidal geometric figure having a base not lower than, for example, ten sections or faces, but without limitation for the invention since it is possible to have more than ten faces or sections without any problem. The implementation of this convex section of a geometric figure having a pyramidal base not lower than ten faces defines a faceted shape on the spreading plate surface that contributes to the control of the material confluence and spread, thus preventing agglomerations, as it has been appreciated in those plates having smooth surfaces of the prior art.

Accordingly, it is achieved by means of the present invention that both the pressurized cold or hot air stream and the material entrained by said stream through the tubes/ducts are relocated as to their conformation when passing through the spreading and/or diffuser spout that shall ease the movement and tracking of the lines defined by the faces of the pyramidal geometric figure of the spreading plate, thus obtaining the most favorable conditions for its homogeneous distribution before contacting the soil. As a result of the convex figure feature, the material does not suffer an impact process but, instead, it is under a process that accompanies the shapes of the spreading plate until the material is released to the environment, thus reducing the undesired fractionation of the material to be applied. With the incorporation of the design of the present spreading plate and together with the possibility that said spreading plate may have a vertical movement in relation to the free end of the coupling tube, both uniformity and precision associated with an optimum dimension of the range of application of materials or mixtures thereof, whether seeds, solid bodies, or powder, and liquids, for pneumatic fertilizer and sowing machines, and the like, are achieved.

The definition of triangular geometric figures in a same spreading plate, where said triangular geometric figures guide the travel of both the pressurized cold or hot air flow and the material entrained by said air flow, favors the containment and travel of both of them since it exerts a positive effect on the spread of the material to be applied by forcing it to have a tridimensional range behavior, thus increasing its work width, resistance to strong winds, continuity in the individual travel, uniformity in the application and homogeneous distribution.

The design of the spreading plate together with the possibility of modifying its vertical movement in relation to the free end of the coupling tube significantly increases the preservation of the materials as to their physical characteristics thus preventing the breakage and disintegration of the material to be applied as a consequence of the hitting action to which the material to be applied is subjected when it leaves the coupling tube and takes contact with the spreading plate, which leads to a better application, less soil damage, and a higher cost/benefit ratio.

It is important to state again that the design applied to the spreading plate of the invention significantly reduces the aggressivity caused by the continuous impacts of the material to be applied, thus giving a higher lifetime level to the wide angle distributor and, consequently, achieving the reduction in maintenance and replacement costs.

1. A wide angle distributor of solid and/or liquid materials for pneumatic fertilizers and/or seeders, of the type comprising a spreading plate that receives the material to be unloaded from and in operative communication with an unloading opening or outlet of a coupling tube which, in turn, is provided above it with an inlet or coupling opening to an unloading tube/duct through which a pressurized air stream flows and entrains the material to be unloaded,
wherein said spreading plate comprises a conical geometry which convex surface faces said unloading opening or outlet of said coupling tube.

2. The wide angle distributor according to claim 1, wherein said spreading plate comprises a pyramidal structure provided with a plurality of faces or sections that define a faceted surface.

3. The wide angle distributor according to claim 2, wherein said spreading plate is mounted on a lower portion of a height adjusting plate provided with at least two respective through sliding paths that are parallel to each other.

4. The wide angle distributor according to claim 1, wherein said spreading plate is mounted on a lower portion of a height adjusting plate provided with at least two respective through sliding paths that are parallel to each other.

5. The wide angle distributor according to claim 1, wherein the wide angle distributor is also provided with a support comprising a “C”-shaped structure which horizontal wings have corresponding fixation cuts of said coupling tube therein, and which vertical wing is provided with respective fixation holes through which fixing elements pass.

6. The wide angle distributor according to claim 1, wherein the fixation holes of the support coincide with said through sliding paths of said height adjusting plate, and said support and said adjusting plate remain fixed in a respective part of a wing or boom of the machine by means of each corresponding fixing element.

7. The wide angle distributor according to claim 2, wherein the fixation holes of the support coincide with said through sliding paths of said height adjusting plate, and said support and said adjusting plate remain fixed in a respective part of a wing or boom of the machine by means of each corresponding fixing element.

8. The wide angle distributor according to claim 3, wherein the fixation holes of the support coincide with said through sliding paths of said height adjusting plate, and said support and said adjusting plate remain fixed in a respective part of a wing or boom of the machine by means of each corresponding fixing element.

9. The wide angle distributor according to claim 4, wherein the fixation holes of the support coincide with said through sliding paths of said height adjusting plate, and said support and said adjusting plate remain fixed in a respective part of a wing or boom of the machine by means of each corresponding fixing element.

10. The wide angle distributor according to claim 5, wherein the fixation holes of the support coincide with said through sliding paths of said height adjusting plate, and said support and said adjusting plate remain fixed in a respective part of a wing or boom of the machine by means of each corresponding fixing element.
